(19) United States
(12) Patent Application Publication
(10) Pub. No.: US 2012/0285911 A1
(43) Pub. Date: Nov. 15, 2012

(54) Rolling Door Security Unit

(75) Inventor: Stanley C. Valiulis, Rockford, IL (US)

(73) Assignee: SOUTHERN IMPERIAL, INC., Rockford, IL (US)

(21) Appl. No.: 13/105,347

(22) Filed: May 11, 2011

(51) Int. Cl. A47F 1/04; E05D 15/06; E06B 3/46

(52) U.S. Cl. 211/59.2; 49/404; 49/414; 49/427

(57) ABSTRACT

A security unit is provided. The security unit provides for retail theft deterrence, including theft by sweeping. The security unit provides a door vertically displaceable between open and closed configurations for selectively allowing access to product disposed on shelving.

### FIELD OF THE INVENTION

This invention generally relates to retail display systems, and more particularly retail display systems configured for loss prevention.

### BACKGROUND OF THE INVENTION

Retail theft continues to be a problem in the retail industry. One practice gaining in popularity is to steal multiple items in a single act, often referred to as “sweeping.” Sweeping is the practice of removing a large quantity of similar goods into a bag or hidden interior pocket, then rapidly exiting the store, despite any theft deterrent devices located at the exit of the store (e.g. RFID sensors, magnetic sensors, cameras, or the like).

In the past, other products have been developed to discourage this practice. For example, locked merchandise cabinets have been used that permit only a store employee to access the merchandise contained therein. However, locked cabinets that must be opened by employees are disadvantageous because the customer must go to find an employee and wait, all of which may lead to the customer deciding not to purchase the item.

As a result, there is a need for a retail display and security system that deters retail theft, especially sweeping.

The invention provides such a security unit. These and other advantages of the invention, as well as additional inventive features, will be apparent from the description of the invention provided herein.

### BRIEF SUMMARY OF THE INVENTION

In one aspect, the invention provides a retail security barrier for securing a retail merchandise display. The retail security barrier includes a pair of side walls and at least one guide member interposed between the pair of side walls. The at least one guide member defines an L-shaped track. The retail security barrier also includes a front door. The front door is slidably received in the L-shaped track and is movable along the L-shaped track between an open and a closed position.

In certain embodiments, the retail security barrier includes at least one biasing member in operative communication with the front door. The at least one biasing member is configured to bias the front door towards the closed position.

In certain embodiments, the side walls of the retail security barrier each include an inner member and an outer member partially overlapping the inner member. The amount of overlap between the inner member and the outer member is adjustable to vary the length of each of the side walls.

In certain embodiments, the at least one guide member includes a pair of guide members in opposed spaced relation and interposed between the pair of sidewalls. The retail security barrier further comprises at least one guide roller extending between the pair of guide members. The at least one guide roller is mounted to the pair of guide members for rotation relative thereto.

In certain embodiment, the at least one guide roller includes a guide rod and a pair of bushings mounted at either end of the guide rod. One bushing is received in a pocket of one guide member, and the other bushing is received in a pocket of the other guide member.

In certain embodiment, the inner and outer members have an upright portion adapted to extend between a lower shelf and an upper shelf to create a side barrier that blocks access to a retail storage space interposed between the upper and lower shelves.

In certain embodiments, the retail security barrier also includes a controller configured to monitor the position of the front door.

In certain embodiments, the at least one guide member defines a pocket for fixedly retaining the biasing member to the at least one guide member. The pocket and biasing member are positioned adjacent to an intersection of a first leg portion and a second leg portion of the at least one guide member. The biasing member contacts the front door. In certain embodiments, the door is positioned within L-shaped track above the biasing member and below at least one roller of the roller arrangement.

In another aspect, the invention provides a secured retail merchandise display. The secured retail merchandise display includes a first retail shelf and a second retail shelf below the first retail shelf. The first and second retail shelves define a retail storage area. A security barrier is interposed between the first and second retail shelves to enclose the retail storage area. The security barrier has an open position configured to permit access to the retail storage area and a closed position configured to prevent access to the retail storage area The secured retail merchandise display also includes a biasing element operably coupled to the security barrier to bias the security barrier from the open position to the closed position.

In certain embodiments, the biasing element of the secured retail merchandise display is in frictional contact with the surface of the door.

In certain embodiments, the secured retail merchandise display also includes a pair of guide members, spaced apart from one another on the second retail shelf. Each of the guide members defines a track. The track is configured to receive the security barrier.

In certain embodiments, the security barrier further comprises a pair of sidewalls positioned between the first retail shelf and the second retail shelf. The pair of guide members are interposed between the pair of sidewalls. In certain embodiments, each of the pair of sidewalls includes an inner member and an outer member, wherein one of the pair of guide members is mounted to one of the inner members, and the other one of the pair of guide members is mounted to the other one of the inner members, and wherein the length of each of the pair of sidewalls is adjustable.

In certain embodiments, the biasing element of the secured retail merchandise display is a rotatable element. The biasing element is configured to resist rotation in a first direction.

In yet another aspect, the invention provides a retail security display for retail products including a flexible door having a first leg and a second leg. The second leg extends in a different direction from than the first leg. The first leg blocks access to the retail products in a closed position. The door is movable from the closed position to an open position. The second leg grows and the first leg decreases as the door moves from the closed position to the open position.

In certain embodiments, the retail security display also includes a pair of sidewalls. The sidewalls are selectively adjustable. The sidewalls are arranged on either side of the flexible door. The retail security display also includes a biasing element. The biasing element is configured to bias the flexible door towards a closed position.

In certain embodiments, the retail security display also includes a guide member. The guide member defines a track configured to receive and guide the door between the open and closed positions.

In certain embodiments, the retail security display also includes a controller. The controller is configured to monitor the position of the door, and to transmit an output based on the position of the door.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective view of an embodiment of a security unit disposed between a top shelf and bottom shelf;

FIG. 2 is an exploded view of the security unit of FIG. 1;

FIG. 3 is a cross-sectional view of the security unit of FIG. 1 taken along the line A-A in FIG. 1;

FIG. 4 is a partial exposed view of the security unit of FIG. 1;

FIG. 5 is a perspective view of an adjustable sidewall of the security unit of FIG. 1 illustrating adjustment of the adjustable sidewall;

FIG. 6 is another perspective view of the adjustable sidewall of the security unit of FIG. 1;

FIG. 7 is the top portion of a cross-sectional view taken along line B-B in FIG. 1 of the upper shelf and one sidewall of the security unit;

FIG. 8 is the bottom portion of a cross-sectional view taken along line B-B in FIG. 1 of the lower shelf and one sidewall of the security unit;

FIG. 9 is a side view of the security unit of FIG. 1;

FIG. 10 is a front view of the security unit of FIG. 1 with the door in a closed configuration; and

FIG. 11 is a front view of the security unit of FIG. 1 with the door in an open configuration.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

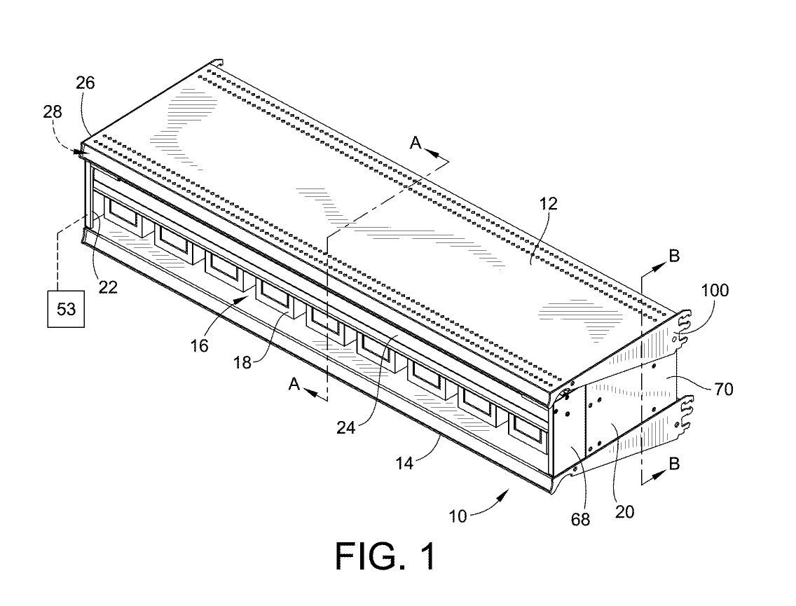

Turning now to the drawings, and particularly FIG. 1, an embodiment of a rolling door security unit 10 is illustrated. As illustrated in FIG. 1, the security unit 10 incorporates upper and lower retail shelves 12, 14 to enclose a retail storage area 16. However, the security unit 10 may be supplied without the upper and lower shelves 12, 14 so that it may be readily integrated with an existing retail display. Further, the security unit 10 may be supplied with top and bottom walls instead of upper and lower shelves 12, 14 so that the security unit 10 can be utilized in retail displays not utilizing shelves (e.g. pegboards, gondola uprights, etc.). As such, the particular embodiment illustrated incorporating upper and lower shelves 12, 14 should be taken by way of example and not by way of limitation.

With regard to FIG. 1, the security unit 10 includes a merchandise barrier that is generally disposed between an upper shelf 12 and a lower shelf 14. The security unit 10, and more particularly the merchandise barrier, includes a pair of adjustable side walls 20 extending between the upper and lower shelves 12, 14, a guide arrangement 22, and a door 24.

The security unit 10 also includes a biasing arrangement 28 configured to urge the door 24 towards a closed configuration and to tend to retain the door 24 in the closed configuration. As will be explained in greater detail below, the aforementioned functionality of the door 24 deters sweeping by requiring a user to hold the door in an open position with one hand, while removing merchandise from the retail storage area 16 with the other hand. As a result, it is more difficult to sweep mass quantities of the merchandise in a single operation.

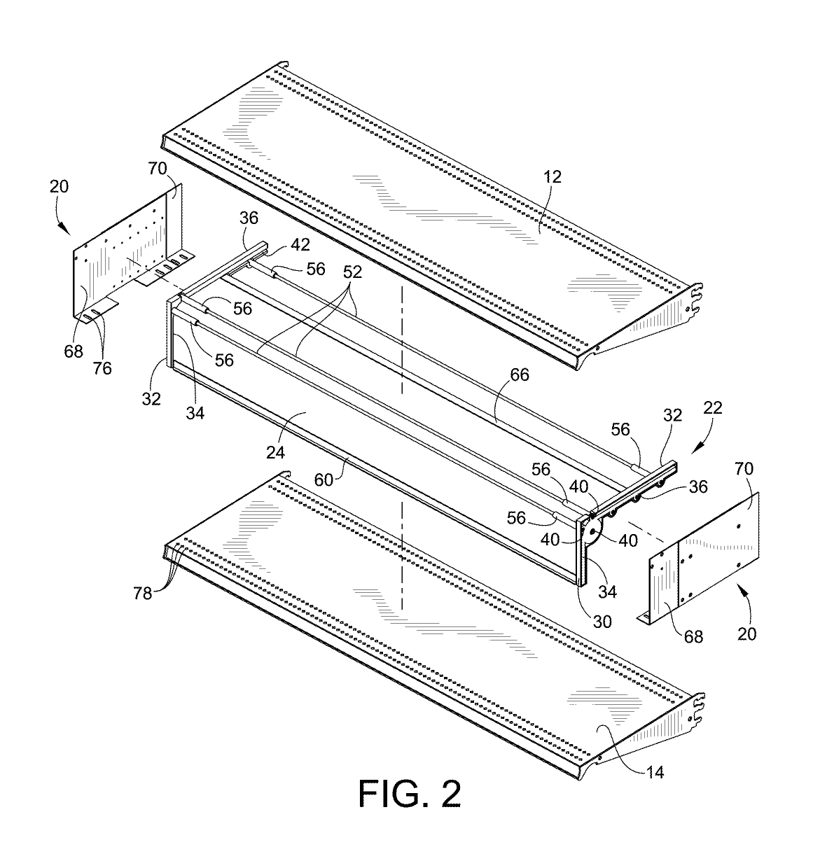

With reference to FIG. 2, the guide arrangement 22 is illustrated. The guide arrangement 22 includes a first guide member 30 and a second guide member 32. The guide members 30, 32 each have a generally L-shaped profile and are spaced apart from one another in an opposed spaced relationship.

Each of the guide members 30, 32 includes a first leg portion 34 and a second leg portion 36 extending from the first leg portion to generally form the L-shape of each guide member 30, 32. When positioned on the lower shelf 14, the first leg portion 34 extends upwardly away from the lower shelf 14 and towards the upper shelf 12, while the second leg portion 36 extends transversely from the first leg portion 34 and parallel to the depth of the shelves 12, 14.

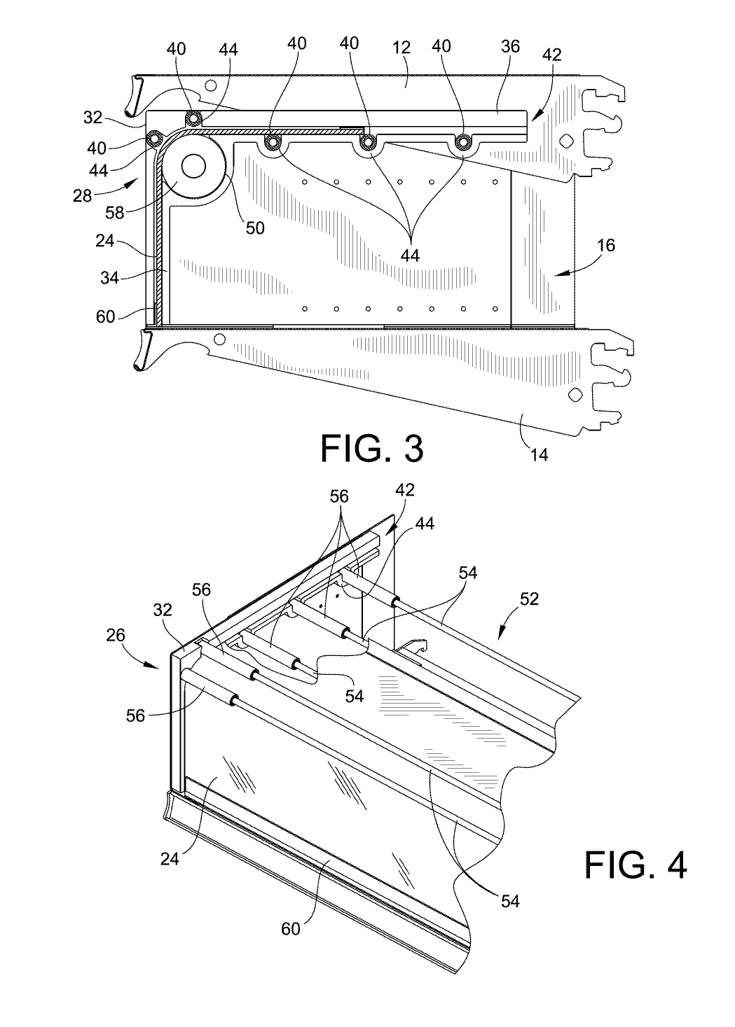

Turning now to FIG. 3, the second guide member 32 is illustrated, and attention is drawn thereto in describing the structural attributes of the both the guide members 30, 32 as they are mirror images of one another. The second guide member 32 includes a plurality of mounting apertures 40 that receive fasteners to removably couple the second guide members 32 to a respective one of the pair of sidewalls 20. The fasteners may be by bolts, screws, nails, adhesive, welding, or any other suitable fastener known in the art.

Still referring to FIG. 3, the second guide member 32 defines along the first leg 34 and second leg 36 a continuous track 42 for slidably receiving and guiding the door 24 between the open and closed configurations introduced above.

The second guide member 32 also incorporates a plurality of pockets 44 disposed above and below the track 42. The pockets 44 generally coincide with the mounting apertures 40. As described below, the pockets 44 receive guide rollers 52 (see FIG. 4) for guiding the door 24 along the track 42.

Also as illustrated in FIG. 3, a pocket 50 is formed at the intersection of the first and second legs 34, 36 of the second guide member 32. The pocket 50 is sized to receive a biasing roller 58 of the biasing arrangement 28. Indeed, the biasing arrangement 28 includes a pair of biasing rollers 58. Each biasing roller 58 is disposed within a respective roller pocket 50 of each of the guide members 30, 32. The biasing rollers 58 each contact and support an edge of the door 24 disposed within the track 42. Each biasing roller 58 is spring loaded to urge the door 24, via contact therewith, to the closed configuration.

From the above it will be recognized that the biasing arrangement 28 can include only a single biasing roller 58 in other embodiments. Further, the biasing arrangement 28 may be in the form of a weighted structure affixed to an end of the door 24 to bias the door 24 to the closed position under gravity alone.

With reference now to FIG. 4, the roller arrangement 26 is further described. The roller arrangement 26 includes a plurality of guide rollers 52 each including a rod 54 and a pair of bushings 56. The bushings 56 are coupled to opposite ends of the rod 54. The pockets 44 (see FIG. 3) receive the bushings 56 and permit rotation of the bushings, and accordingly the guide rollers 52, relative to the pockets 44. The bushings 56 contact opposite edges of the door 24 (see e.g. FIG. 2) to assist in the smooth movement of the door 24 within the track 42 when transitioning between the open and closed configurations.

Still referring to FIG. 4, the door 24 is movable between an open and a closed configuration along the track 42. The door 24 is designed to conform to the shape of the track 42, and as such, may be made of a continuous flexible material, or formed from segmented portions hingedly connected to one another. The door 24 may be transparent, translucent, or opaque, and may include indicia including product information, advertisements, or other information regarding the product behind the door or other products.

With momentary reference back to FIG. 3, the door 24 has a first leg and a second leg when positioned within the track 42. The first leg is generally disposed within the first leg portion 34 of the second guide member 32 (as well as the first guide member 30 although not shown) and prevents access to the retail storage area 16. The second leg of the door 24 is disposed within the second leg portion 36 of the second guide member 32. As the door 24 is transitioned from the closed position to the open position, the second leg will grow in length and the first leg will decrease in length.

Referring back to FIG. 2, the door 24 includes a first trim bar 60 coupled to or integrally formed with the door 24 proximate the bottom front edge of the door 24. The first trim bar 60 may be formed from metal, stiff plastic, or any other suitable material, and is configured to provide horizontal rigidity to the door 24, and provide a leading guide edge of the door 24 to assist movement within the track 42 (see FIGS. 3 and 4). Additionally, the first trim bar 60 can also incorporate a handle to assist in opening the door 24.

Still referring to FIG. 2, the door 24 also may provide a second trim bar 66 disposed proximate the opposite end of the door 24 from the first trim bar 60. The second trim bar 66 may also be formed from a substantially stiff or rigid material suitable for providing horizontal rigidity to the door 24. The second trim bar 66 may also function as a guide at the trailing edge of the door 24 in a same or similar was as the first trim bar 60. The trim bars 60, 66 may be adhered to the door 24 by an adhesive, or otherwise mechanically affixed to the door 24 via fasteners or the like.

While the door 24 is described above as directly contacting the biasing rollers 58 and the guide rollers 52, in an alternate embodiment, some or all of the biasing rollers 58 and the bushing portions 56 of the guide rollers 52 may be geared to allow for receiving the teeth of a rack gear. The door 24 may be provided with a pliable rack gear configuration adhered to or integrally formed with the door 24 proximate at least one of its edges configured to interface with the geared portion of the biasing rollers 58 and guide rollers 52.

Referring back to FIG. 1, as illustrated, a controller 53 is provided in electrical communication with various sensory and alerting equipment (not shown). The controller 53 may be configured to indicate when the door 24 is opened, when the door 24 is held open for a period of time, when multiple doors are opened at once, or various other conditions with regard to the door 24. For example, the controller 53 may monitor a sensor including a pressure switch coupled with the lower shelf 14 to indicate to the controller when, for example, the door 24 is held open for an extended period of time. The controller 53 may alert store personnel by playing a sound, flashing a light, sending an SMS message to an employee, focusing a camera on the affected shelf 12, etc. The described arrangement is merely exemplary. Many other suitable sensory and alerting arrangements are envisioned.

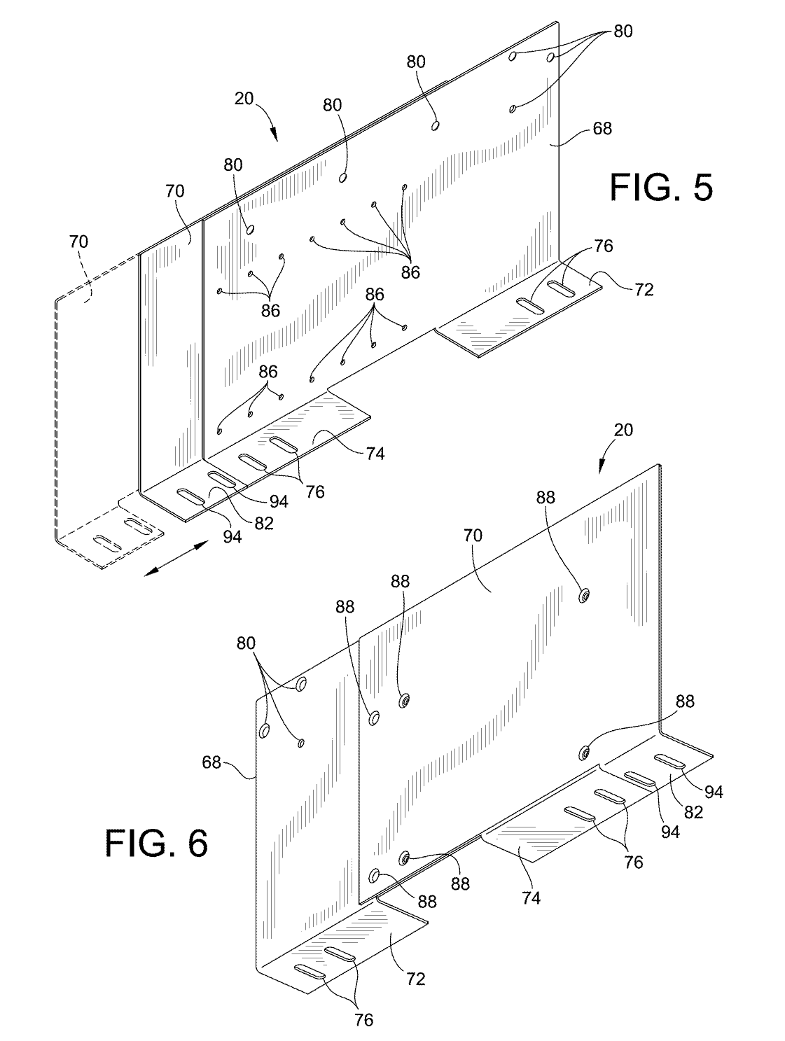

With reference now to FIG. 5, the sidewalls 20 are further described. Each sidewall 20 includes an inner member 68 and an outer member 70. The inner and outer members 68, 70 are positionable relative to one another to increase or decrease the overall length of the sidewall 20. It will be recognized that this functionality allows for the security unit 10 to adapt to various shelf depths to fully enclose a particular retail storage area 16 (see FIG. 1).

The inner member 68 is generally a rigid plate that includes a first attachment flange 72 and a second attachment flange 74, with the flanges 72, 74 formed by bending the same into a generally 90° orientation as illustrated. Both flanges 72, 74 include attachment apertures 76 formed through the flanges 72, 74 for fixedly mounting the inner member 68 to the lower shelf 14 (see shelf apertures 78 of FIG. 1), or in other embodiments, to some other retail support structure. The apertures 76 are slotted to permit fine adjustment of the location of the inner member 68 relative to the lower shelf 14.

The upright portion of the inner member 68 includes two parallel rows of coupling apertures 86. The rows extend along the length of the inner member 68 and are alignable with corresponding apertures 88 (see FIG. 6) of the outer member 70 for adjustably coupling the inner member 68 to the outer member 70.

The inner member 68 also includes attachment apertures 80 that align with the mounting apertures 40 of the guide members 30, 32 shown in FIG. 3 for affixing the guide members 30, 32 to the inner member 68 of the sidewall 20.

The outer member 70 is similar in shape to the inner member 68 in that it also includes an upright portion and an attachment flange 82 extending away from the upright portion at a generally 90° orientation as illustrated. The attachment flange 82 of the outer member 70 includes apertures 94 formed through the attachment flange for affixing the outer member 70 to the lower shelf 14 (see FIG. 1) in the same manner as the inner guide member 68. The apertures 94 are slotted to permit fine adjustment of the location of the outer member 70 relative to the lower shelf 14.

Turning now to FIG. 6, the outer member 70 is adjustable relative to the inner member 68, as introduced above, to increase or decrease the overall length of the sidewall 20. This adjustment is effectuated by aligning the apertures 86 (see FIG. 5) of the inner member 68 with the apertures 88 of the outer member 70 and inserting a fastener through the aligned apertures 86, 88. When installed, the outer member 70 overlaps a portion of the inner member 68 to minimize or prevent access to the retail storage area 16 from a side of the security unit 10.

As can be seen in FIG. 6, the inner and outer member 68, 70 are configurable to a minimum shelf depth, at which the second attachment flange 74 of the inner member 68 will abut the attachment flange 82 of the outer member 70. The inner and outer members 68, 70 and the attachment flanges 72, 74, 82 may be formed from metal, plastic, combinations thereof, or any other suitable material or combination of materials known in the art.

Turning now to FIG. 7, the inner and outer guide members 68, 70 are illustrated in the aforementioned overlapping configuration. Both the inner and outer guide members 68, 70 extend vertically underneath the upper shelf 12, such that a side wall 100 of the upper shelf 12 overlaps the inner and outer guide members 68, 70. As shown, the inner and outer guide members 68, 70 extend vertically beyond a bottom edge 102 of the sidewall 100 of the upper shelf 12.

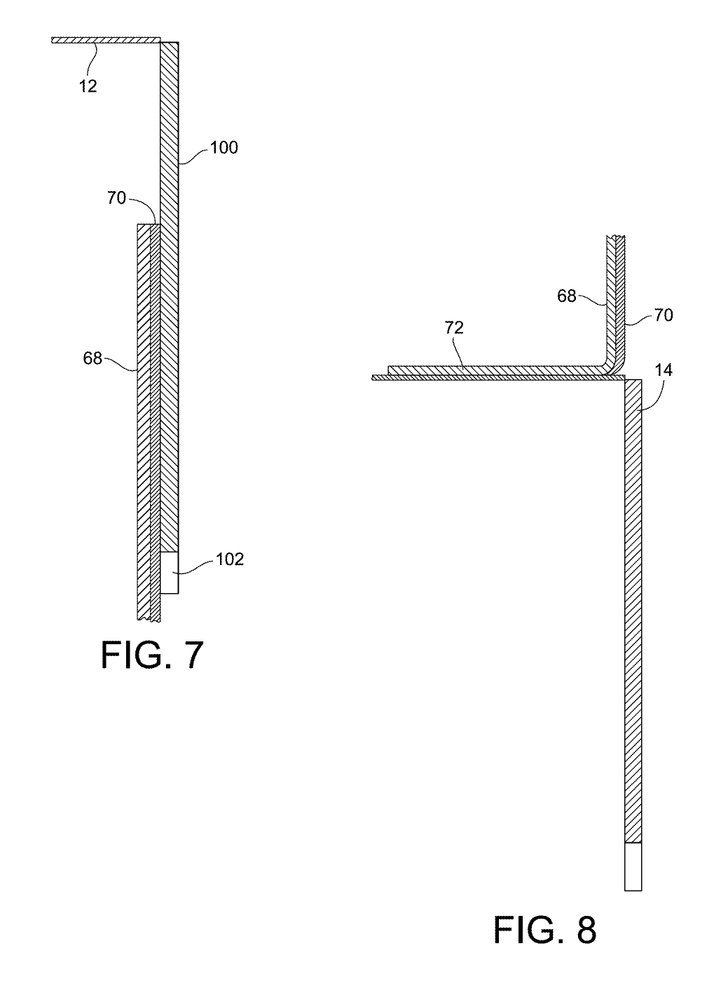

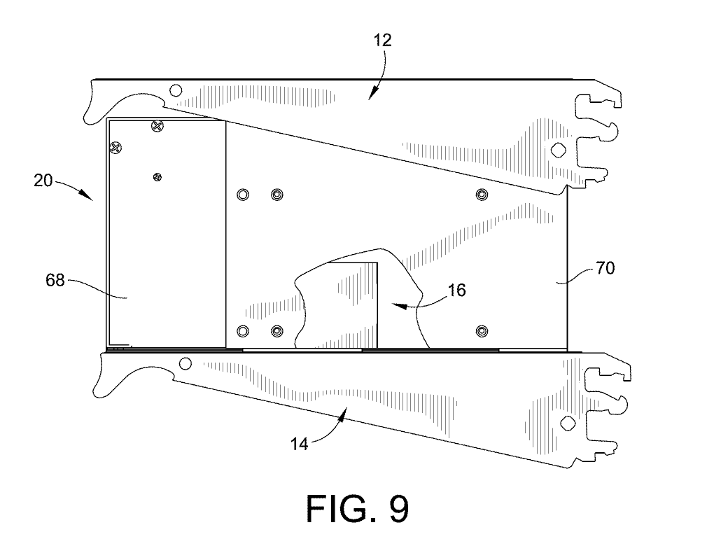

With reference to FIG. 8, as described above, the inner and outer guide members 68, 70 are also attached to lower shelf 14. As a result of this arrangement and as shown in FIG. 9, it will be recognized that the sidewalls 20 and upper and lower shelves 12, 14 form a barrier. This barrier minimizes or prevents side access into the retail storage area 16 (see FIG. 1) from a side thereof.

Having described structural aspects of an embodiment of the present invention, the detailed description will now focus on the installation and operation of the same.

To install the security unit 10, the door 24 and guide rollers 52 are assembled between the first and second guide members 30, 32. Thereafter, the first and second guide members 30, 32 are affixed to the inner guide members 68 of each respective sidewall 20. Thereafter, the sidewalls 20 are adjusted to an appropriate shelf depth and mounted to the lower shelf 14. The lower shelf may already be installed in a vertical support structure, or the above assembly may be installed as a unit on a vertical support structure. The upper shelf 12 is then installed above the sidewalls 20 as shown at FIG. 7 to the vertical support structure. In embodiments incorporating a controller 53, the controller 53 can also be configured before, after, or during any of the steps described above.

With reference to FIG. 10, the door 24 is illustrated in a closed position and is in the form of a transparent vinyl door allowing a potential customer to see the product 18 within the security unit 10 through the door 24. Additionally, the door 24 may include indicia 104 printed on or adhered thereto including pictures, words, advertisement, etc.

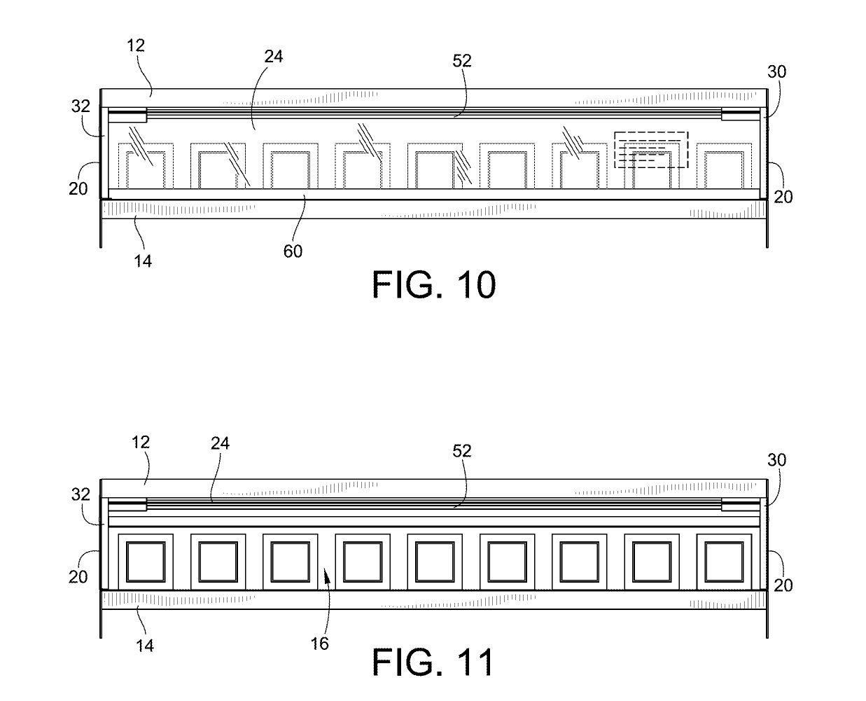

To bias the door 24 to an open position, the customer grasps a portion of the trim bar 60 and urges the door upwardly to gain access to the product, as shown in FIG. 11. However, because the biasing arrangement 28 urges the door 24 to return to the closed configuration, as in FIG. 10, a customer the customer is required to continue to use one hand to hold the door 24 in the open configuration while removing a product 18 from the retail storage area 16. Thus, a potential thief would be unable to use both hands to sweep large quantities of products from a shelf, and therefore the security unit 10 advantageously deters sweeping the product 18.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A retail security barrier for securing a retail merchandise display, the retail security barrier comprising:
a pair of sidewalls;
at least one guide member interposed between the pair of sidewalls and defining an L-shaped track; and
a front door slidably received in the L-shaped track and movable along the L-shaped track between an open and a closed position.

2. The retail security barrier of claim 1, further comprising at least one biasing member in operative communication with the front door, the at least one biasing member configured to bias the front door towards the closed position.

3. The retail security barrier of claim 1, wherein the pair of sidewalls each include an inner member and an outer member partially overlapping the inner member.

4. The retail security barrier of claim 3, wherein the amount of overlap between the inner member and the outer member is adjustable to vary the length of each of the sidewalls.

5. The retail security barrier of claim 4, wherein the at least one guide member includes a pair of guide members in opposed spaced relation and interposed between the pair of sidewalls, the retail security barrier further comprising at least one guide roller extending between the pair of guide members, wherein the at least one guide roller is mounted to the pair of guide members for rotation relative thereto.

6. The retail security barrier of claim 5, wherein the at least one guide roller includes a guide rod and a pair of bushings mounted at either end of the guide rod, wherein one bushing is received in a pocket of one guide member, and wherein the other bushing is received in a pocket of the other guide member.

7. The retail security barrier of claim 2, wherein the at least one guide member includes a pair of guide members in opposed spaced relation, and wherein the retail security barrier further comprises a roller arrangement extending between the pair of guide members the roller arrangement in contact with the front door and adapted to assist transitioning the door between the open and the closed positions.

8. The retail security barrier of claim 1, wherein the inner and outer members have an upright portion adapted to extend between a lower shelf and an upper shelf to create a side barrier that blocks access to a retail storage space interposed between the upper and lower shelves.

9. The retail security barrier of claim 7, wherein the at least one guide member defines a pocket for fixedly retaining the biasing member to the at least one guide member, the pocket and biasing member positioned adjacent to an intersection of a first leg portion and a second leg portion of the at least one guide member, wherein the biasing member contacts the front door.

10. The retail security barrier of claim 9, wherein the door is positioned within L-shaped track above the biasing member and below at least one roller of the roller arrangement.

11. A secured retail merchandise display, comprising:
a first retail shelf;
a second retail shelf below the first retail shelf, the first and second retail shelves defining a retail storage area;
a security barrier interposed between the first and second retail shelves to enclose the retail storage area, wherein the security barrier has an open position configured to permit access to the retail storage area, and a closed position configured to prevent access to the retail storage area; and
a biasing element operably coupled to the security barrier to bias the security barrier from the open position to the closed position.

12. The secured retail merchandise display of claim 11, wherein the biasing element is in frictional contact with the surface of the door.

13. The secured retail merchandise display of claim 11, further comprising a pair of guide members each defining a track configured to receive the security barrier.

14. The secured retail merchandise display of claim 13, wherein the security barrier further comprises a pair of sidewalls positioned between the first retail shelf and the second retail shelf, and wherein the pair of guide members are interposed between the pair of sidewalls.

15. The secured retail merchandise display of claim 14, wherein each of the pair of sidewalls includes an inner member and an outer member, wherein one of the pair of guide members is mounted to one of the inner members, and the other one of the pair of guide members is mounted to the other one of the inner members, and wherein the length of each of the pair of sidewalls is adjustable.

16. The secured retail merchandise display of claim 15, wherein the biasing element is a rotatable element configured to resist rotation in a first direction.

17. A retail security display for retail products comprising:
a flexible door having a first leg and a second leg;
the second leg extending in a different direction than the first leg;
the first leg blocking access to the retail products in a closed position;
the door being movable from the closed position to an open position; and
the second leg growing and the first leg decreasing as the door moves from the closed position to the open position.

18. The retail security display of claim 16, further comprising a pair of selectably adjustable arranged sidewalls and configured on either side of the flexible door.

19. The retail security display of claim 16, further comprising a biasing element configured to bias the flexible door towards a closed position.

20. The retail security display of claim 16, further comprising a guide member defining a track configured to receive and guide the door between the closed and open positions.
